(19) United States
(12) Patent Application Publication
(10) Pub. No.: US 2006/0259665 A1
(43) Pub. Date: Nov. 16, 2006

(54) Configurable multiple write-enhanced direct memory access unit

(76) Inventors: Sanjive Agarwala, Richardson, TX (US); Kyle Castille, Houston, TX (US); Quang Dieu An, Plano, TX (US); David Q. Bell, Frederick, MD (US); Natarajan Kurian Seshan, Bellaire, TX (US)

Correspondence Address: TEXAS INSTRUMENTS INCORPORATED, P O BOX 655474, M/S 3999, DALLAS, TX, 75265, US

(21) Appl. No.: 11/128,597

(22) Filed: May 13, 2005

(51) Int. Cl. G06F 13/38

(52) U.S. Cl. 710/62

(57) ABSTRACT

The configurable multiple write-enhanced EDMA of this invention processes multiple priority channels and utilizes as much write data bus as practical. A write queue stores write requests with their corresponding data width and priority. A dispatch circuit dispatches a highest priority maximum data width write request if that is the highest priority stored write request or if the prior dispatch was not a maximum data width write request. The dispatch circuit dispatches two write requests if their total data width is less than or equal to the maximum data width and they both have a priority higher than the highest priority maximum data width write request.

### TECHNICAL FIELD OF THE INVENTION

The technical field of this invention is direct memory access units in data processing devices.

### BACKGROUND OF THE INVENTION

Current microprocessor designs need to centralize data transfer operations under control of integrated functional units known as data transfer access units or enhanced direct memory access (EDMA) units. EDMA is of most interest here and specifically of interest are EDMA designs employing hub-and-port style architecture. Such EDMAs feature a hub unit, which maintains a queue of transfer requests and provides priority protocol and proper interfacing for the handling of a large number of such requests. Secondly hub-and-port EDMAs have one or more hub interface units (HIU), which each provide a seamless interface between the EDMA hub and its ports. Ports are typically external application units (AU) otherwise known as peripheral units. Internal memory ports are also included among the EDMA ports.

FIG. 1 illustrates the essentials of a microprocessor system having EDMA 100 and central processing unit (CPU) 101. EDMA 100 includes transfer controller 102 and hub interface units (HIU) 104, 105, and 106. Communication between the transfer controller hub unit 102 and HIUs 104, 105, and 106 employs buses 103, 107, 108, 109, and 110. Each HIU provides interface to a single port. Peripheral unit 114 and 115 communication with corresponding HIUs 104 and 105 via respective paths 111 and 112. Each EDMA port also includes the internal memory port device 116 which communications with HIU 106 via path 113. The EDMA 100 responds to transfer requests not only from CPU 101 but also from any of the ports it services. Transfer requests (TR) handled by transfer controller (TC) hub unit 102 involve transfer of data from one port to another. Transfer commands reside in transfer request packets that give all the detailed parameters of a transfer.

FIG. 2 illustrates the functional units of the transfer controller portion of EDMA 200. The transfer request processor 201 receives transfer requests from CPU 230 and from one or more HIU 210 via path 228. Transfer request processor passes these requests to queue manager 202. Queue manager 202 receives data transfer request packets (TRP), places them in queue manager RAM 203 and assigns them to one of the P channel priority levels. It is helpful to distinguish TRPs stored in the queue manager RAM 203 as being in the queue, and TRPs stored in the channel registers block 204 as being active. For example, for N=32, EDMA 200 could have four channel priorities and channel register block 204 could hold eight active transfer packets at each priority level. At any given time channel register block 204 could hold up to 32 total TRPs.

If there is no channel available for direct processing of a TRP coming into queue manager 202, it is stored in queue manager RAM 203. The TRP is then submitted to the channel registers 204 at a later time when a channel becomes available. Source ready signal 213 and destination ready signal 215 indicate availability of a channel space within the channel registers 204. Channel registers 204 interface with source pipeline 205 and destination pipeline 206. Source pipeline 205 and destination pipeline 206 are address calculation units for source (read) and destination (write) operations. These pipelines broadcast outputs to M ports of EDMA 200 through M hub interface units 210, which drive the M possible external ports units. FIG. 2 illustrates just one port 229 as an example. When source pipeline space is available, source pipeline 204 passes source ready signal 216 to the channel registers 204, which passes source ready signal 213 to queue manager 202. When destination pipeline space is available, destination pipeline 206 passes ready signal 219 to the channel registers 204, which passes ready signal 215 to queue manager 202. Queue manager block 202 passes source read commands developed from the transfer packets to channel registers 204 via path 214 and hence to source pipeline 205 via path 217. Queue manager block 202 passes destination write commands developed from the transfer packets to channel registers 204 via path 214 and hence to destination pipeline 205 via path 220. Source valid signal 218 and destination valid signal 221 from channel registers 204 alert the respective pipelines that a valid transfer is ready to be processed.

Signals broadcast from transfer controller (TC) to the hub interface units (HIU) 210 and returning from the HIU to the TC include: source read command 222; destination write command 223; destination write data 224; read response information 227 from HIU to read response FIFO buffer 212; read return data from ports 225 to be stored in write data FIFO buffer 211; TC acknowledge flag 226 from response acknowledge logic 209 to HIU 210.

FIG. 3 illustrates queue manager 300 and its interface within the EDMA hub unit to channel registers 304, source pipeline 305 and destination pipeline 306. Channel parameters registers 301 and port parameters registers 302 store critical data regarding, for example, types of transfers, mode information, status, and other information critical to the transfer process. Channel registers 304 pass information used in source pipeline 305 for generation of the read commands 322. Similarly channel registers 304 pass information used in destination pipeline 306 for the generation of write command 324 directing passage of write data 323 to the HIU. Read data 325 and read response information 327 from the port returns to destination pipeline 306 via data router unit 310. Data router unit 310 includes the two FIFOs, write data FIFO buffer 311 and read response FIFO buffer 312. Response acknowledge logic 309 generates response acknowledge (ACK) signal 326 to the HIU that the data read has been received.

When a channel register 304 within the EDMA is empty, a data request, either source ready 318 or destination ready 319, is sent for that channel to queue manager 300. If queue manager 300 has another EDMA entry for that channel, then it reads out the transfer request packet for that transfer and sends it via path 320 to channel registers 304. This information is saved in the appropriate channel, and that channel is activated inside the channel registers, to begin transferring data. During the transfer, the source and destination pipelines incrementally modify some of the transfer parameters and send out the updated values to the rest of the EDMA. Once the EDMA finishes processing that channel, the channel registers will receive a source ready signal 328 or a destination ready signal 329. Queue manager 300 then detects the completion of a transfer and acts to send another request to channel registers 304.

### SUMMARY OF THE INVENTION

The configurable multiple write-enhanced EDMA of this invention processes multiple priority channels and utilizes the full write data bus maximizing EDMA throughput and performance. The EDMA bases write functionality on write port width and selectively issues one or multiple writes. Write data is divided into two halves allowing the EDMA to fit the full write port width into one full width or two half widths as desired.

### BRIEF DESCRIPTION OF THE DRAWINGS

These and other aspects of this invention are illustrated in the drawings, in which:

FIG. 1: illustrates the high level functional diagram of an enhanced direct memory access unit (EDMA) with hub-and-port architecture driven by a central processor unit and having a transfer controller interfacing with several hub interface units driving peripheral unit functions (Prior Art);

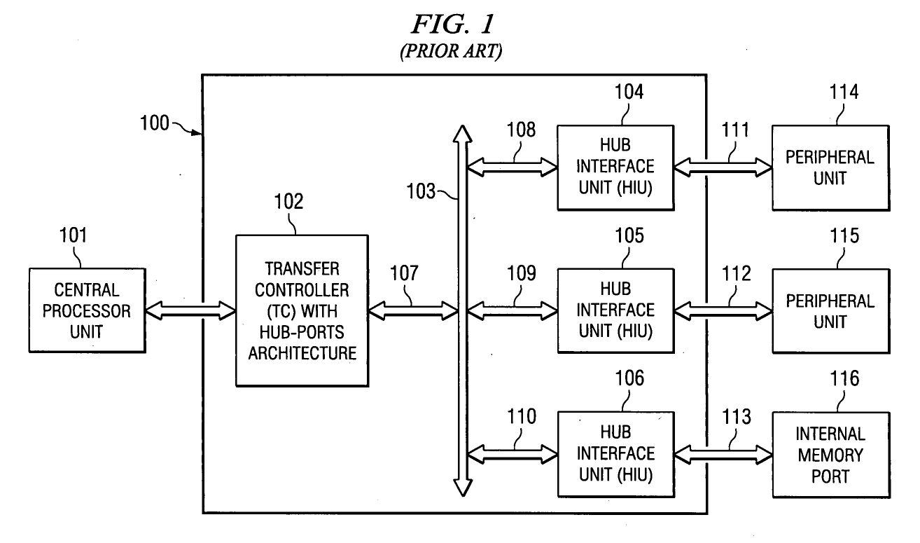

FIG. 2: illustrates in a functional block diagram the basic principal features of the EDMA (Prior Art);

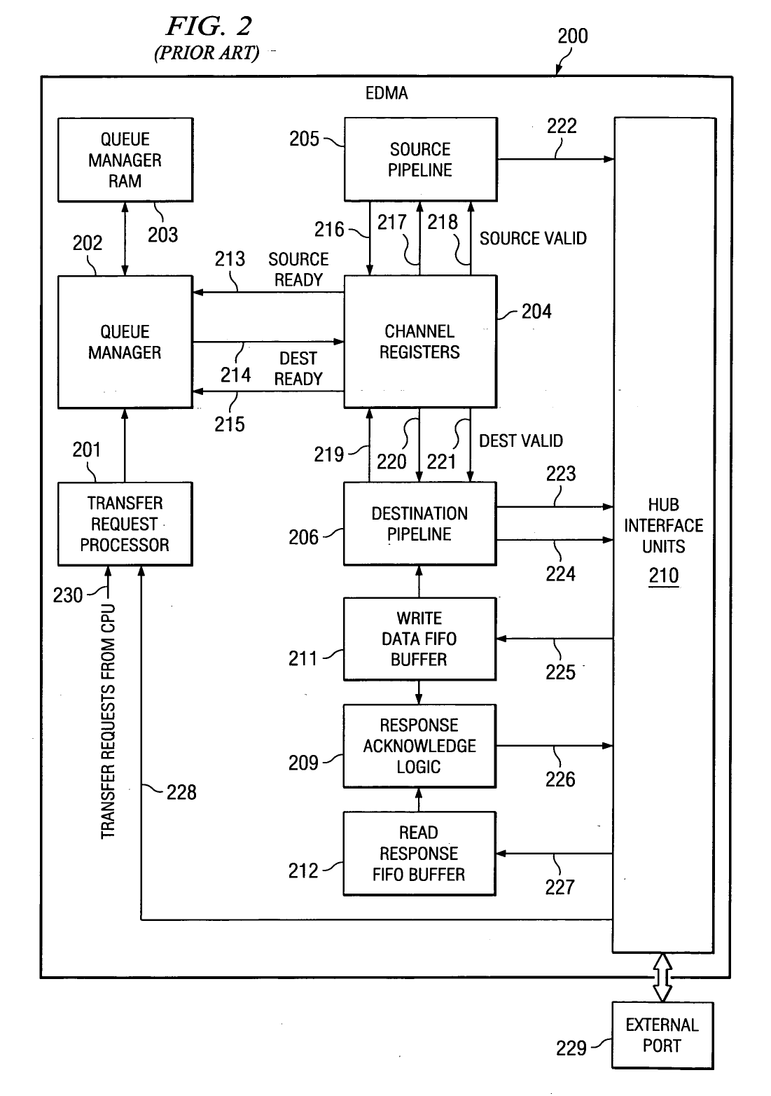

FIG. 3: illustrates the queue manager interface to the EDMA source and destination pipelines (Prior Art);

FIG. 4: illustrates the block diagram of the multiple write-enhanced EDMA of this invention;

FIG. 5: illustrates the block diagram of the write data buffers and the destination pipeline of the multiple write-enhanced EDMA of this invention.

### DETAILED DESCRIPTION OF PREFERRED EMBODIMENTS

Channel based EDMA systems normally will only process one priority channel and issue one write per cycle regardless of write port bus width. A 32-bit or 64-bit write can consume as much EDMA port bandwidth as a 128 bit write. This invention uses more EDMA bandwidth basing write command dispatch on the write port width and selectively issuing one or more writes, splitting the write data to fit the write port width if needed. Using information of the write port bus width, one or more writes can be issued to the ports to utilize the whole EDMA bandwidth. This invention is a configurable multiple write EDMA capable of processing multiple priority channels and utilizing the whole write data bus.

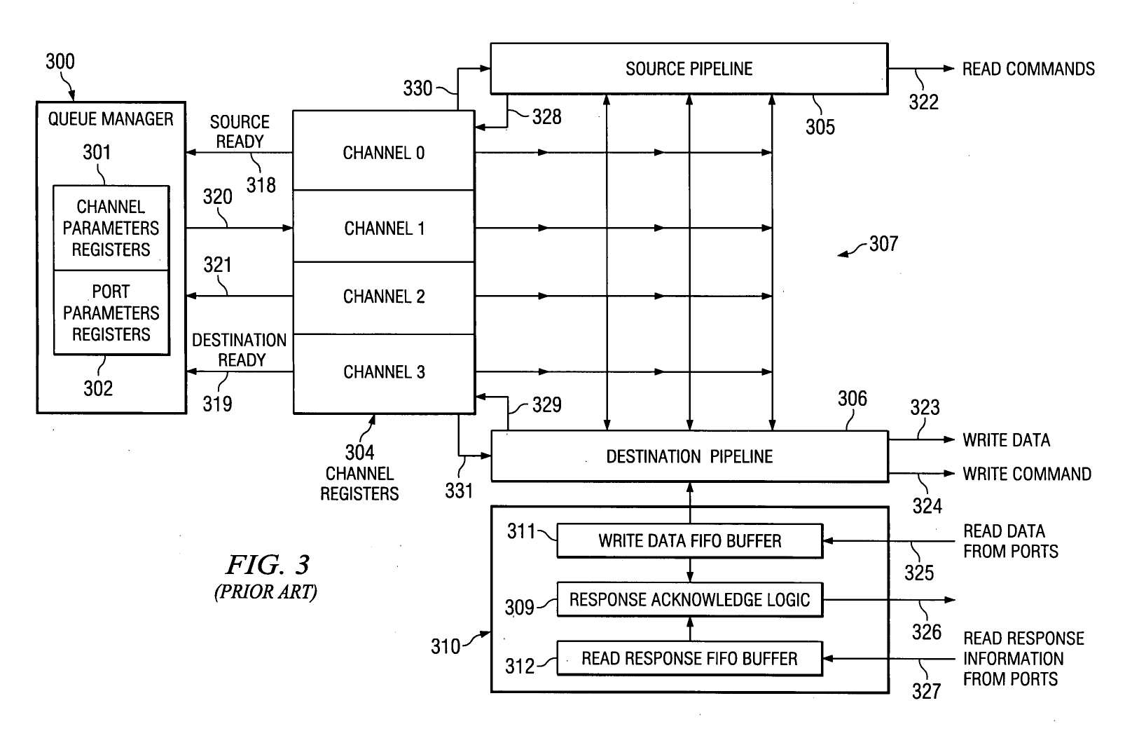

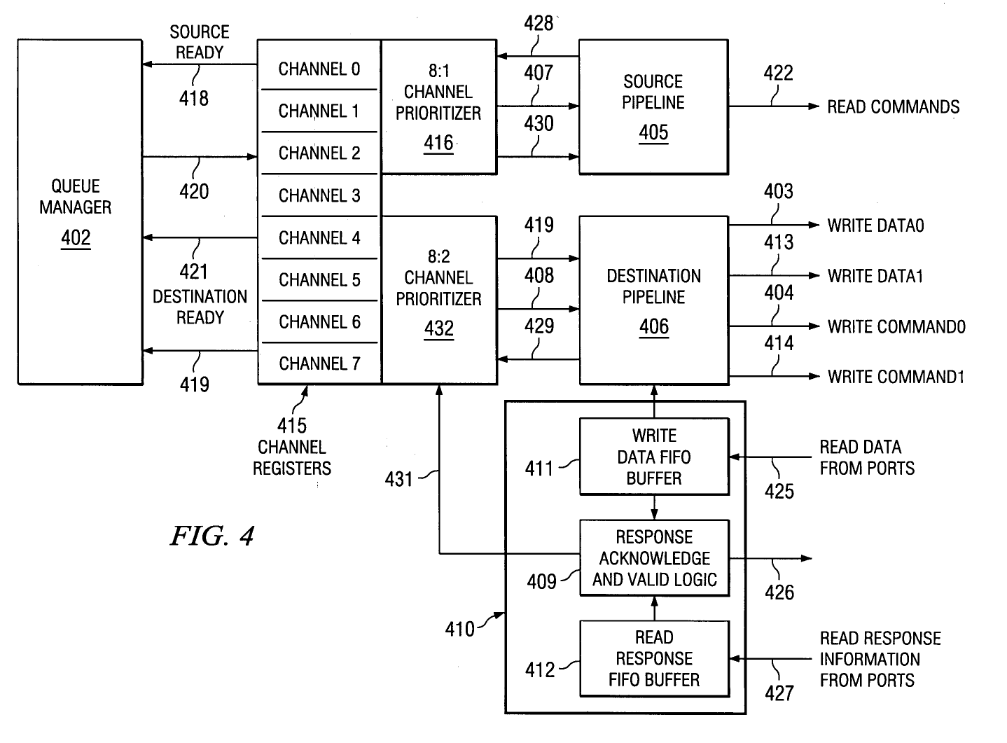

FIG. 4 illustrates an example 8-channel 128 bit EDMA capable of issuing one or two write commands to the ports. The write ports are either 128-bit or 64-bit. This 8-chnnel EDMA is similar to the 4-channle EDMA illustrated in FIG. 3 and uses similar reference numbers for similar parts. FIG. 4 illustrates two channel prioritizers: an 8:1 prioritizer 416 for source commands; and an 8:2 prioritizer 432 for destination commands. Destination pipeline 406 may drive two write commands: write command0 404 and write command1 414. Destination pipeline 406 may also drive two corresponding portions of write data: write data0 403 and write data1 413.

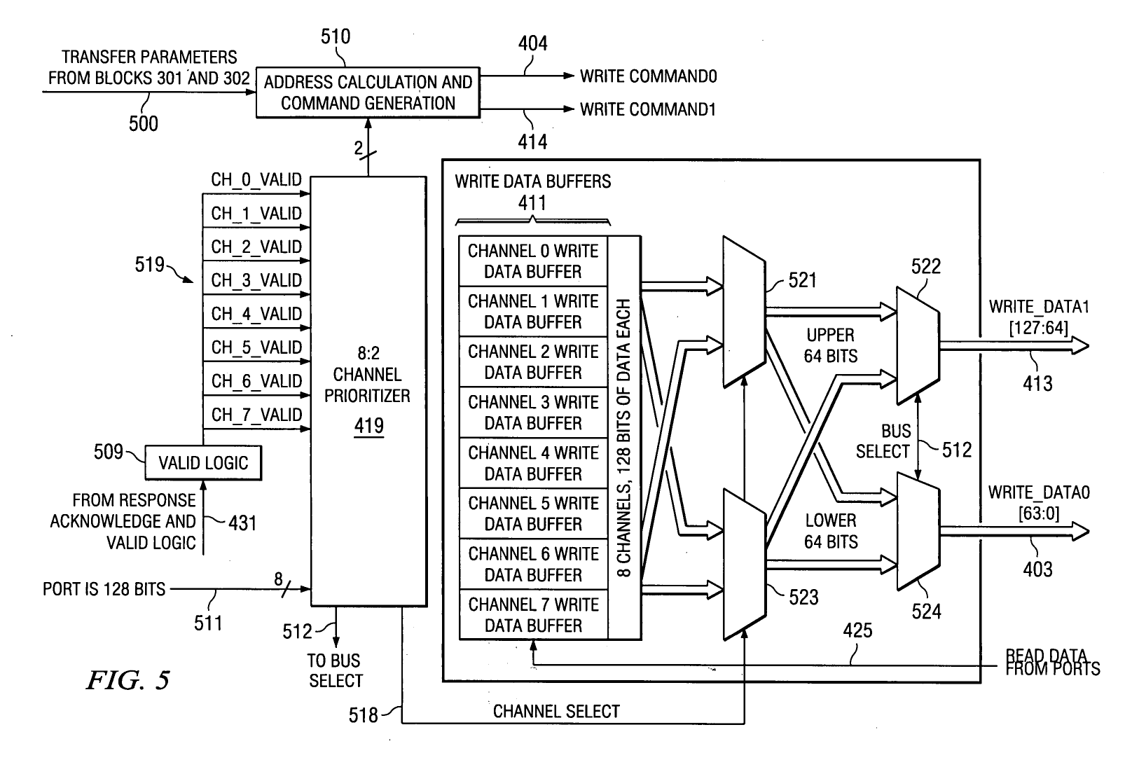

FIG. 5 illustrates further details of the destination pipeline block 406, the write data FIFO buffer 411 and the channel prioritizer 416. For each processing channel, the read data 425 from the read port is stored in a separate write data buffer 411 for the corresponding channel. Channel_valid signals 519 from channel valid logic 509 signal which channel has data ready to be written out. Port_is_{—}128-bit signal 511 is a hard-wired bus indicating that the corresponding port is a 128-bit port. The 8:2 prioritizer 416 determines which pending channel or channels can be processed. One or two channels can be issued depending on the priorities and write port width. The prioritization rule is:

1. If the highest priority channel is a 128-bit write port, select this channel;

2. If the highest priority and second highest channels are not 128-bit write ports, select these two channels; and

3. If the last issued channel was not a 128-bit write port and there is a pending 128-bit port channel, select this channel. This protocol tends to utilize the whole 128-bit bus as much as possible.

Addressing calculation and command generation block 510 bases write commands on the channel or channels selected by the rules above. Transfer parameters 500 stored within the queue manager provide information for the address calculation. The EDMA issues write commands 404 and 414 to write ports along with corresponding write data 403 and 413 and updates the transfer information.

Each channel has its own write data buffer within write data FIFO buffer 411 to store the read return data 425. Depending on processing channels, one or two channel valid signals 431 are selected from the write data FIFO buffer 411 and response acknowledge and valid logic block 409 (FIG. 4). This involves two 8 to 1 multiplexers 521 and 523. Two 2 to 1 multiplexers 522 and 524 are used to send the whole 128-bit write data to the 128-bit port or split into two 64-bit data in predetermined order to two different 64 bit ports.

Depending on system performance requirement, actual write port width could be 16, 32, 64 or 128 bits. This technique can be easily configured and expanded to handle multiple writes and pack the data to the ports to perfectly match the EDMA write data bus.

What is claimed is:

1. A data transfer controller comprising:
a write queue storing a plurality of write requests, each write request specifying one of a plurality of data widths and one of a plurality of priorities;
a data transfer channel with a maximum data width, said maximum data width at least as large as a largest of said plurality of data widths; and
a dispatch circuit connected to said write queue and said data transfer channel, said dispatch circuit operable to dispatch write requests stored in said write queue to said data transfer channel in an order based upon said specified data width and specified priority of said plurality of write requests.

2. The data transfer controller of claim 1, wherein:
said dispatch circuit is operable to dispatch the highest priority maximum data width write request if said write request specifies a highest priority of all write requests.

3. The data transfer controller of claim 1, wherein:
said dispatch circuit is operable to simultaneously dispatch two write requests if a total specified data width of said two write requests is less than or equal to said maximum data width and both said write requests specify a priority higher than a highest priority of any write request specifying said maximum data width.

4. The data transfer controller of claim 1, wherein:
said dispatch circuit is operable to dispatch a write request specifying said maximum data width having a highest priority among stored write requests specifying said maximum data width if a most recently dispatched write request did not specify said maximum data width.

5. The data transfer controller of claim 1, wherein:
said maximum data width is 128 bits.

6. The data transfer controller of claim 1, wherein:
said varying data widths of said write requests include 16 bits, 32 bits, 64 bits and 128 bits.

7. A data transfer method comprising the steps of:
storing a plurality of write requests, each write request specifying one of a plurality of data widths and one of a plurality of priorities; and
dispatching said stored write requests to a data transfer channel having a maximum data width in an order based upon said specified data width and specified priority of said plurality of write requests.

8. The data transfer method of claim 7, wherein:
said step of dispatching said stored write requests includes dispatching the highest priority maximum data width write request if said write request specifies a highest priority of all write requests.

9. The data transfer method of claim 6, wherein:
said step of dispatching said stored write requests includes simultaneously dispatching two write requests if a total specified data width of said two write requests is less than said maximum data width and both said write requests specify a priority higher than a highest priority of any write request specifying said maximum data width.

10. The data transfer method of claim 6, wherein:
said step of dispatching said stored write requests includes dispatching a write request specifying said maximum data width having a highest priority among stored write requests specifying said maximum data width if a most recently dispatched write request did not specify said maximum data width.
